(19) United States
(12) Patent Application Publication
(10) Pub. No.: US 2026/0331839 A1
(43) Pub. Date: Oct. 22, 2026

(54) ELECTRICAL CONNECTOR AND CONNECTOR ASSEMBLY WITH MOVABLE ADAPTER TERMINAL

(71) Applicant: DONGGUAN LUXSHARE TECHNOLOGIES CO., LTD, Dongguan City (CN)

(72) Inventors: Tao SONG, Dongguan City (CN); Kun LIU, Dongguan City (CN); Feng ZHENG, Dongguan City (CN); Peibin WANG, Dongguan City (CN); Yuanxin WANG, Dongguan City (CN)

(73) Assignee: DONGGUAN LUXSHARE TECHNOLOGIES CO., LTD, Dongguan City (CN)

(21) Appl. No.: 19/725,101

(22) Filed: Jun. 30, 2026

Related U.S. Application Data
(63) Continuation-in-part of application No. 19/573,745, filed on Mar. 20, 2026.

(30) Foreign Application Priority Data
Mar. 21, 2025 (CN) 202510346915.6
Jul. 14, 2025 (CN) 202521470457.9

(51) Int. Cl. H01R 13/6587; H01R 12/58; H01R 12/72

(52) U.S. Cl. CPC H01R 13/6587; H01R 12/58; H01R 12/724; H01R 12/727

(57) ABSTRACT

An electrical connector includes a housing, a terminal module and a mounting block. The terminal module includes a first conductive terminal having a first contact portion and a first tail portion. The mounting block is mounted on the terminal module. The mounting block includes an insulating plastic and a first adapter terminal disposed in the insulating plastic. The first adapter terminal includes a terminal portion and an elastic component abutting against the terminal portion. The first adapter terminal is electrically connected to the first tail portion of the first conductive terminal. The terminal portion is configured to be movable along a telescopic direction of the elastic component. A connector assembly having the electrical connector is also disclosed.

### CROSS-REFERENCE TO RELATED APPLICATIONS

This patent application is a continuation-in-part of U.S. Patent Application Ser. No. 19/573,745, filed on Mar. 20, 2026, which claims priority of a Chinese Patent Application No. 202521470457.9, filed on Jul. 14, 2025 and titled “ELECTRICAL CONNECTOR AND CONNECTOR ASSEMBLY and Chinese Patent Application No. 202510346915.6, filed on Mar. 21, 2025.

### TECHNICAL FIELD

The present disclosure relates to an electrical connector and a connector assembly, belonging to the technical field of electrical connectors.

### BACKGROUND

A connector assembly in the related art typically includes a plug connector and a receptacle connector. The receptacle connector is usually mounted on a circuit board. The receptacle connector generally includes a first housing, a plurality of receptacle terminal modules installed in the first housing, and a mounting plate cooperating with the first housing to secure the receptacle terminal modules. The receptacle terminal modules include an insulating plate, a plurality of receptacle signal terminals secured to the insulating plate, a plurality of receptacle ground terminals secured to the insulating plate, a first shielding plate disposed on one side of the receptacle signals and the ground terminals, and a second shielding plate disposed on another side of the receptacle signals and the ground terminals.

Each receptacle signal terminal has a terminal mounting leg configured for being mounted to the circuit board. However, the terminal mounting leg in the related art still has room for improvement.

### SUMMARY

An embodiment of the present disclosure adopts the following technical solution: an electrical connector including: a housing, the housing defining an installation slot; a terminal module, the terminal module being at least partially disposed in the installation slot; the terminal module including a first conductive terminal, and the first conductive terminal including a first contact portion and a first tail portion; and a mounting block, the mounting block being mounted to the terminal module, the mounting block including an insulating plastic and a first adapter terminal disposed in the insulating plastic, the first adapter terminal including a terminal portion and an elastic component abutting against the terminal portion; wherein the first adapter terminal is electrically connected to the first tail portion of the first conductive terminal, and the terminal portion is configured to be movable along a telescopic direction of the elastic component.

An embodiment of the present disclosure adopts the following technical solution: a connector assembly including: an electrical connector including: a housing defining an installation slot; a terminal module being at least partially disposed in the installation slot; the terminal module including a first conductive terminal, and the first conductive terminal including a first contact portion and a first tail portion; and a mounting block being mounted to the terminal module, the mounting block including an insulating plastic and a first adapter terminal disposed in the insulating plastic, the first adapter terminal including a terminal portion and an elastic component abutting against the terminal portion; wherein the first adapter terminal is electrically connected to the first tail portion of the first conductive terminal, and the terminal portion is configured to be movable along a telescopic direction of the elastic component; and a circuit board provided with a first conductive pad; wherein the terminal portion of the electrical connector is configured to elastically abut against the first conductive pad of the circuit board.

### BRIEF DESCRIPTION OF DRAWINGS

FIG. 1 is a perspective schematic view of a connector assembly in accordance with an embodiment of the present disclosure;

FIG. 2 is a perspective schematic view of FIG. 1 from another angle;

FIG. 3 is a further partial exploded perspective view of FIG. 2;

FIG. 4 is a partial enlarged view of circled portion B in FIG. 3;

FIG. 5 is a partial exploded perspective view of the connector assembly in accordance with the embodiment of the present disclosure, with the circuit board separated;

FIG. 6 is a partial enlarged view of circled portion C in FIG. 5;

FIG. 7 is a further partial exploded perspective view after removing the circuit board from FIG. 5;

FIG. 8 is a partial exploded perspective view of an electrical connector;

FIG. 9 is a partial enlarged view of circled portion D in FIG. 8;

FIG. 10 is a partial exploded perspective view of FIG. 8 from another angle;

FIG. 11 is a partial exploded perspective view of an installation module;

FIG. 12 is a partial exploded perspective view of FIG. 11 from another angle;

FIG. 13 is a partial enlarged view of circled portion E in FIG. 12;

FIG. 14 is a front view of a terminal module in FIG. 11;

FIG. 15 is a rear view of the terminal module in FIG. 11;

FIG. 16 is a left view of the terminal module in FIG. 11;

FIG. 17 is a right view of the terminal module in FIG. 11;

FIG. 18 is a partial exploded perspective view of the terminal module in FIG. 11;

FIG. 19 is a partial enlarged view of circled portion F in FIG. 18;

FIG. 20 is a partial exploded perspective view of FIG. 18 from another angle;

FIG. 21 is a further partial exploded perspective view after removing an insulating plate from FIG. 18;

FIG. 22 is a partial exploded perspective view of FIG. 21 from another angle;

FIG. 23 is a partial exploded perspective view of FIG. 18;

FIG. 24 is a further partial exploded perspective view of FIG. 23;

FIG. 25 is a partial exploded perspective view of an extended shielding shell assembly;

FIG. 26 is a partial exploded perspective view of FIG. 25 from another angle;

FIG. 27 is a partial exploded perspective view of a mounting block;

FIG. 28 is a partial exploded perspective view of FIG. 27 from another angle;

FIG. 29 is a further exploded perspective view of FIG. 27;

FIG. 30 is an exploded perspective view of FIG. 29 from another angle;

FIG. 31 is a cross-sectional schematic view taken along line G-G in FIG. 1; and

FIG. 32 is a partial enlarged view of framed portion H in FIG. 31.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

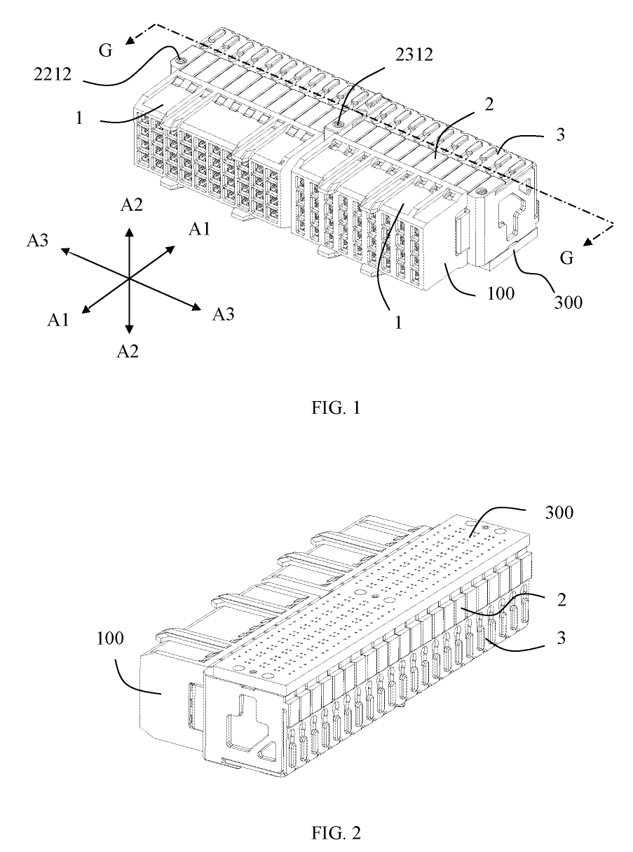

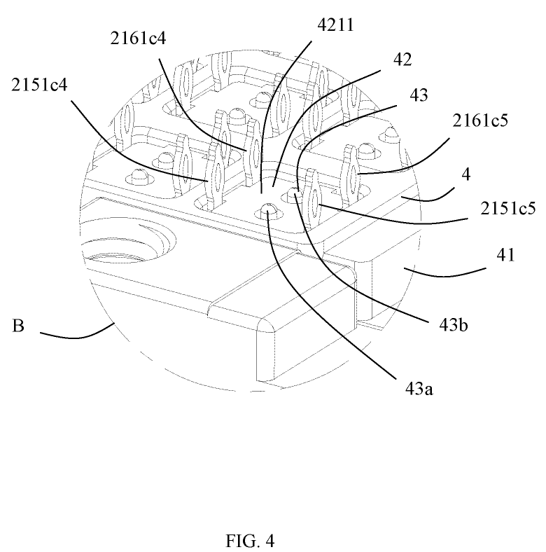

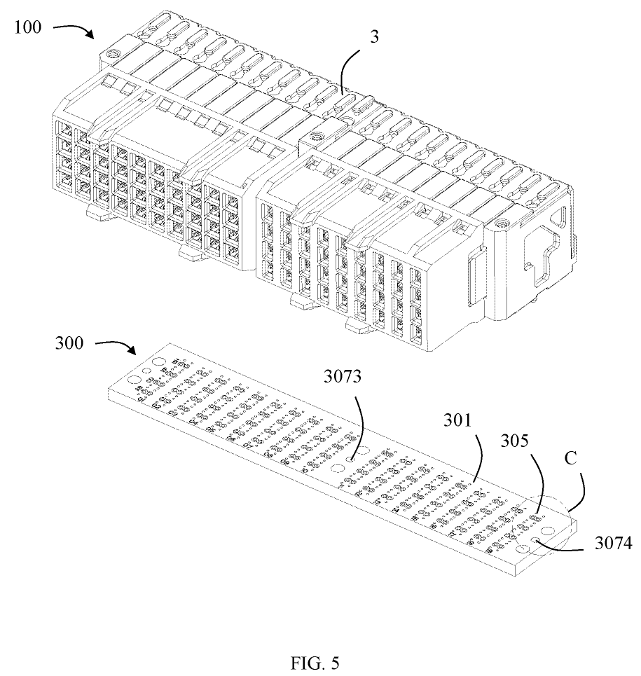

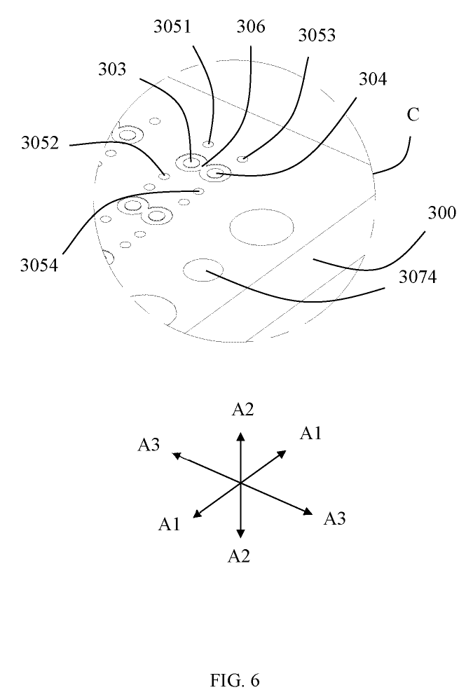

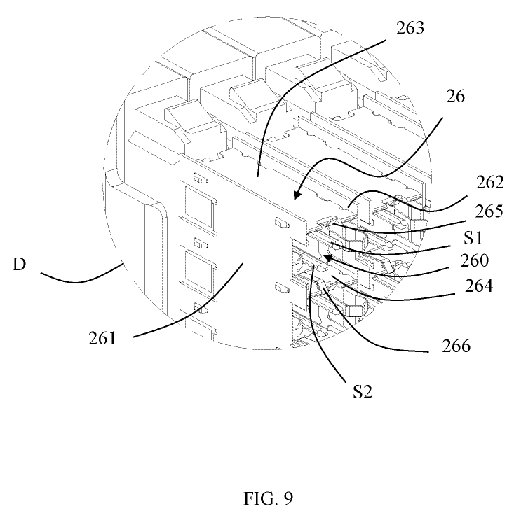

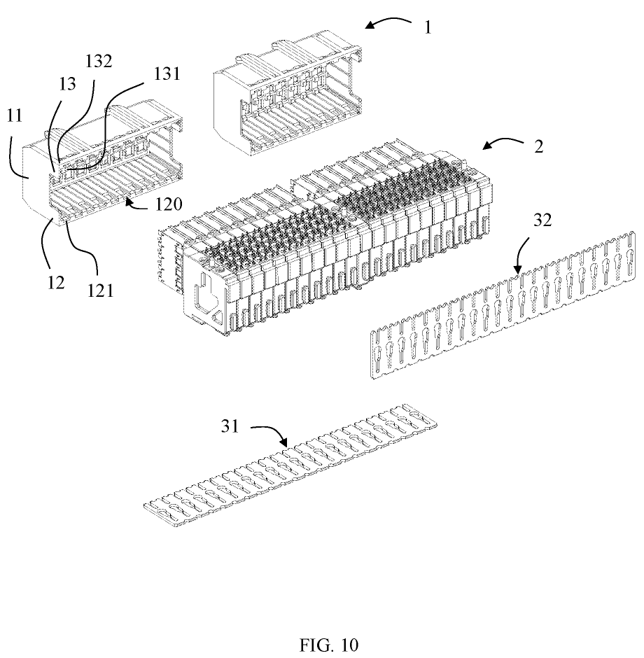

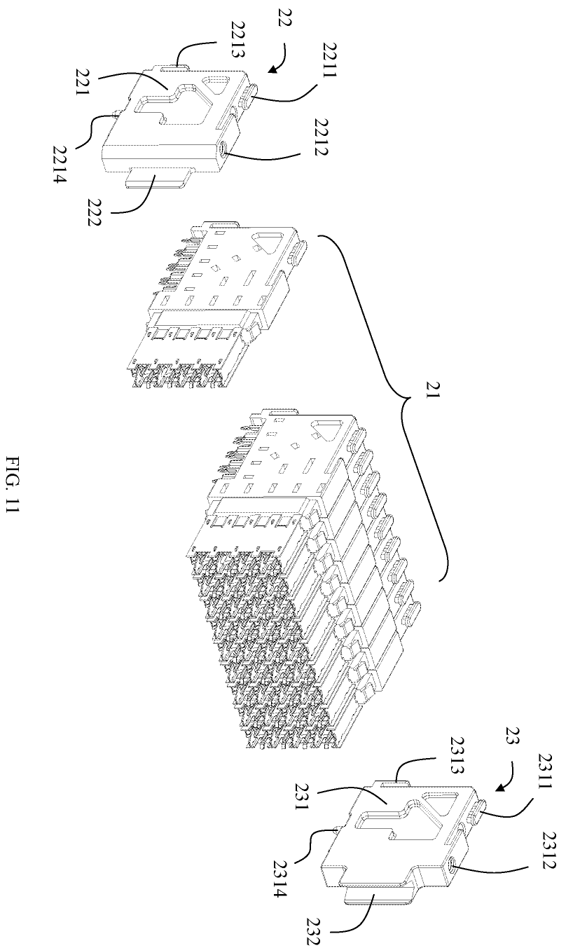

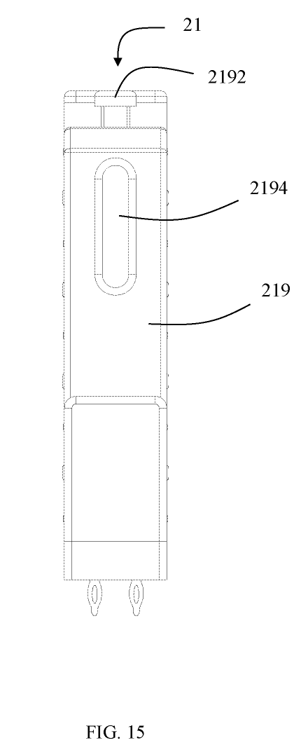

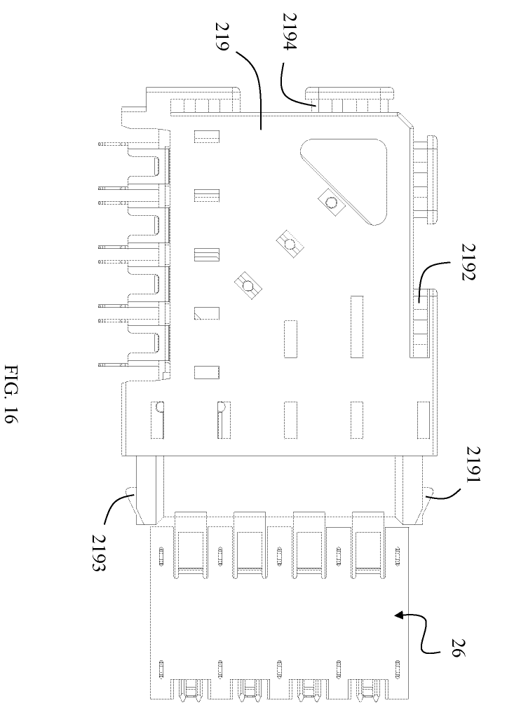

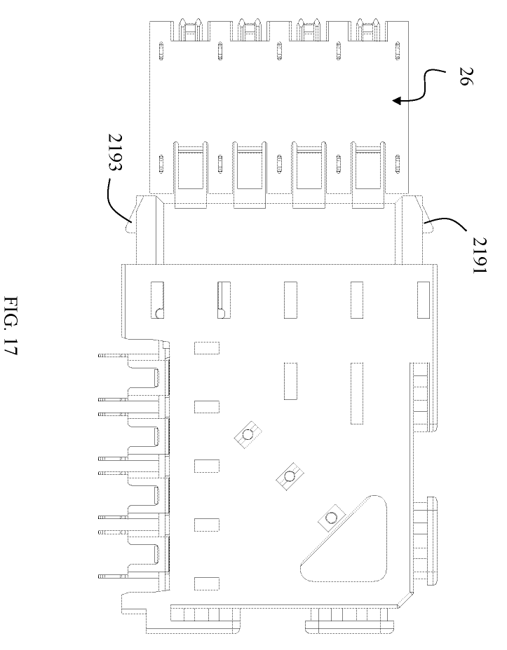

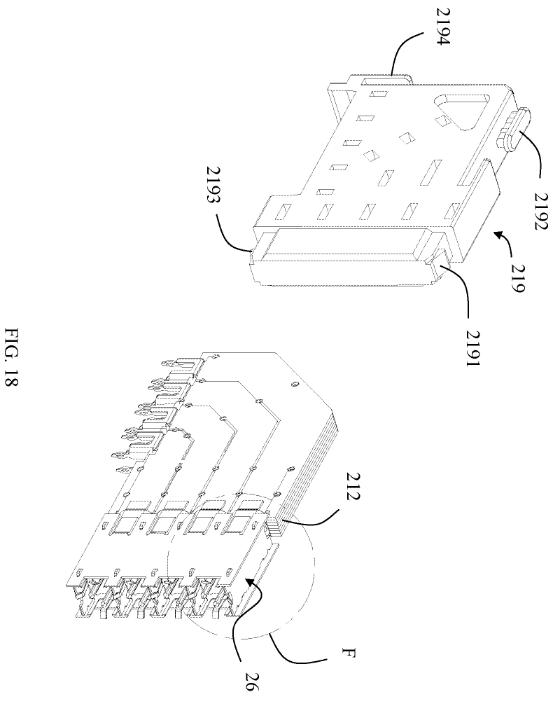

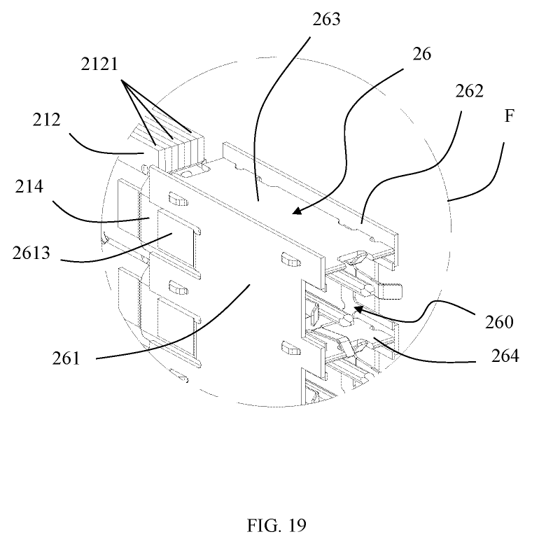

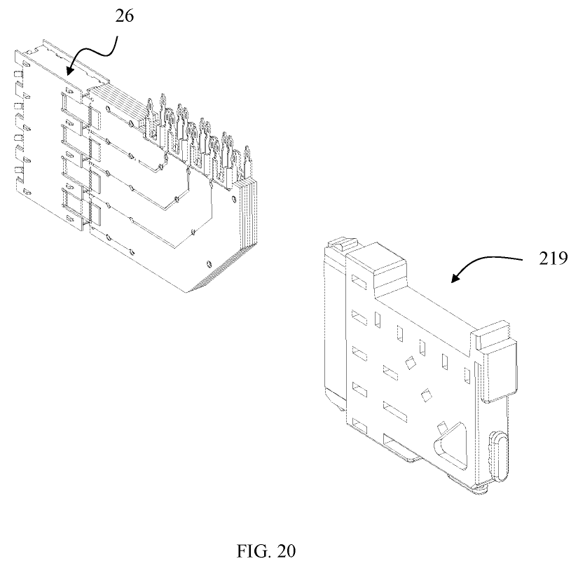

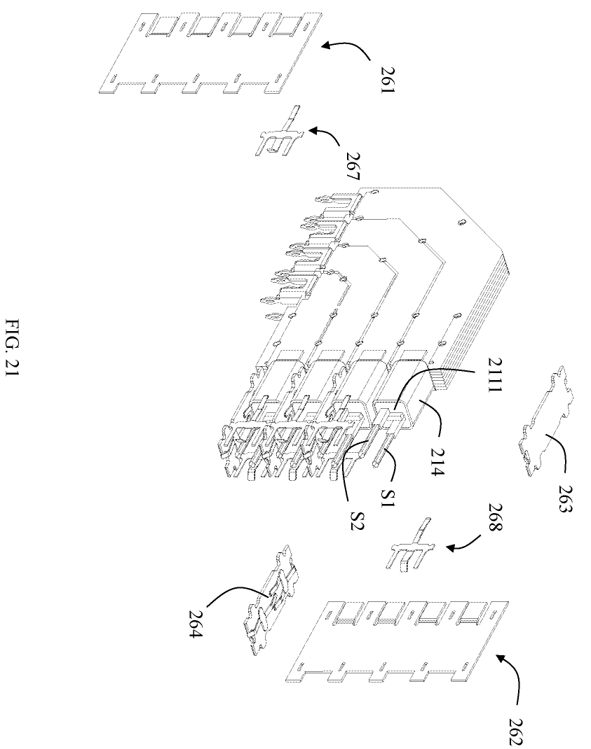

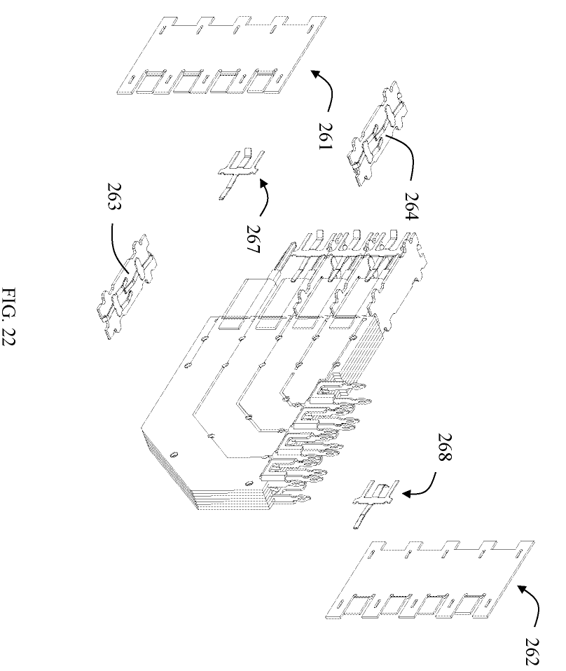

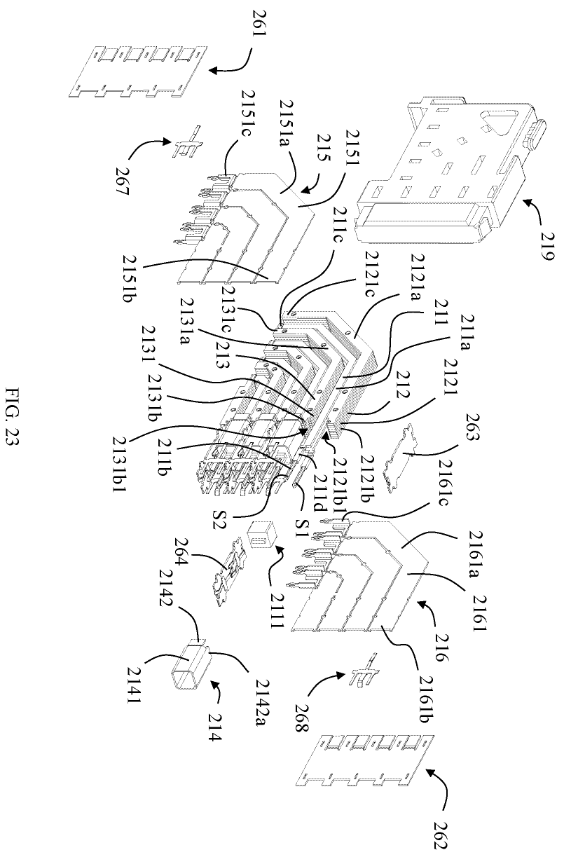

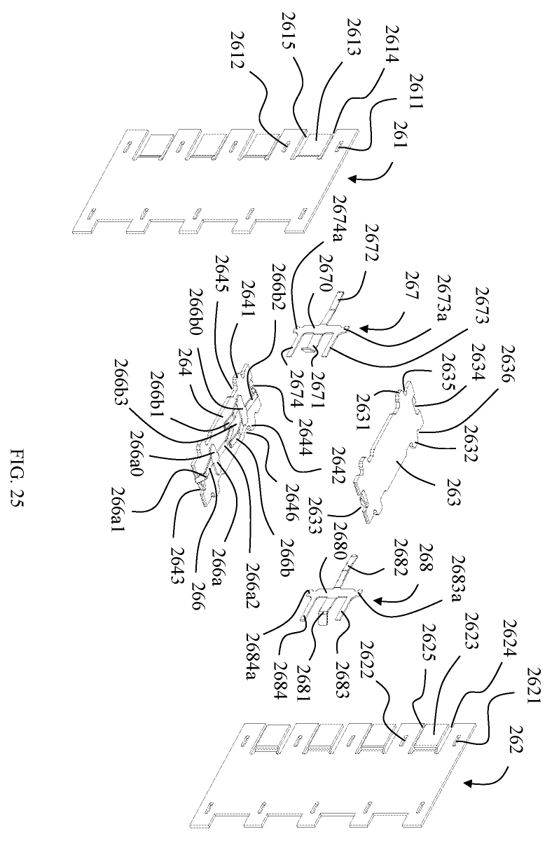

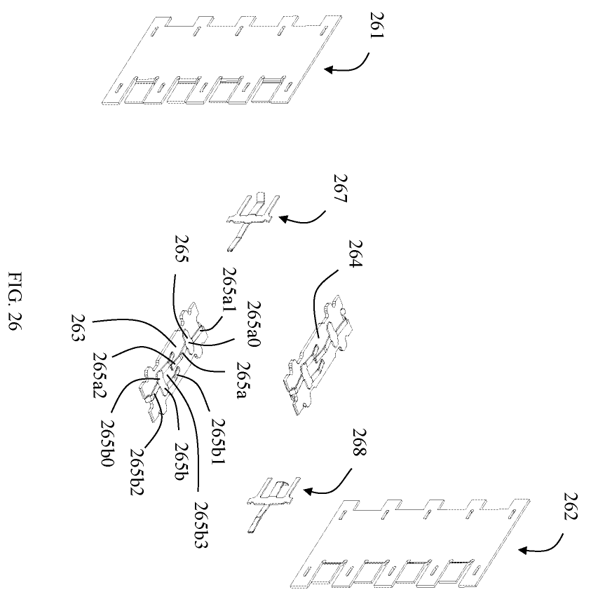

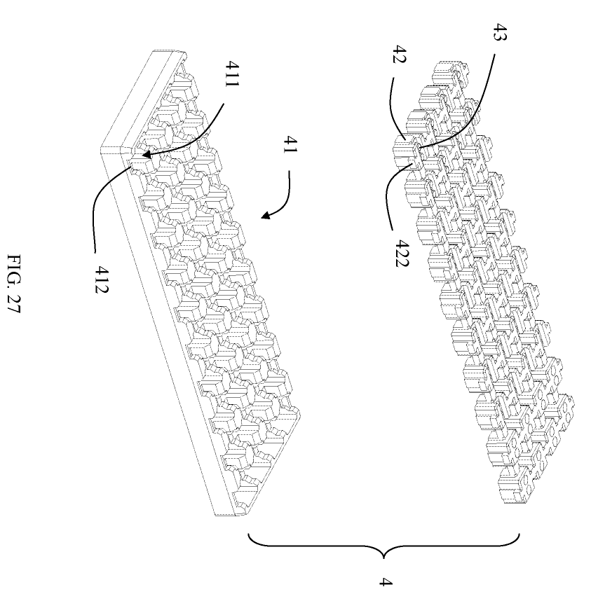

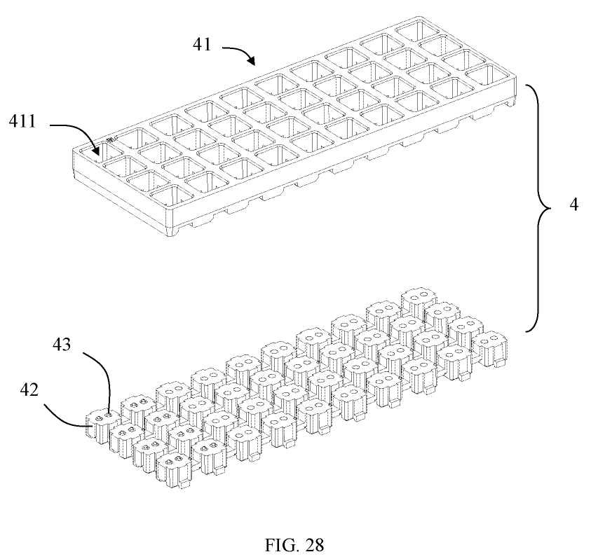

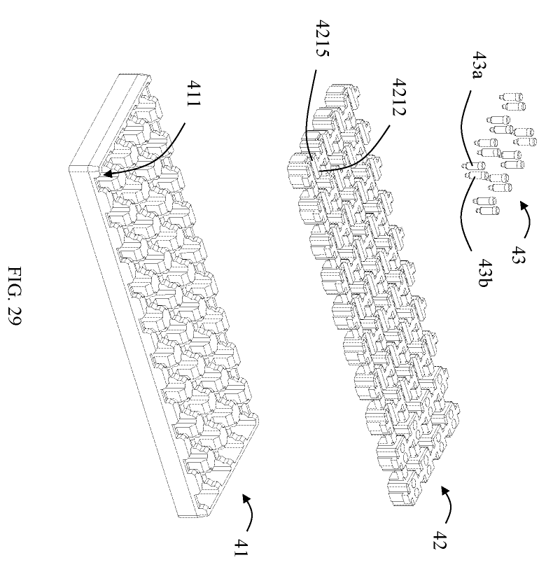

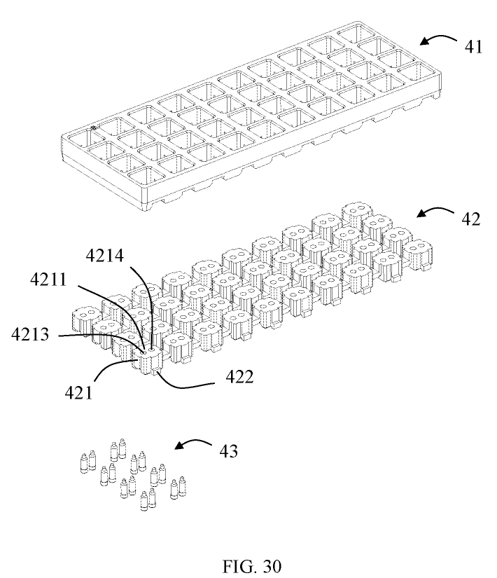

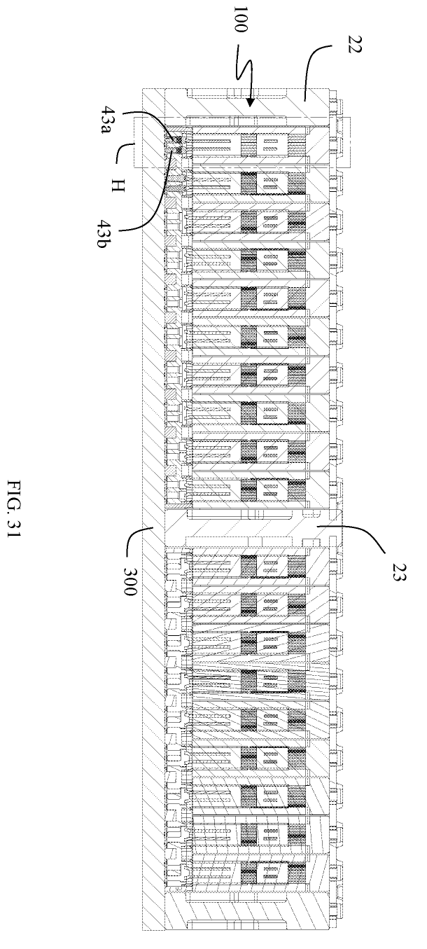

Referring to FIGS. 1-32 , the present disclosure discloses a connector assembly which includes an electrical connector 100 and a circuit board 300 for mating with the electrical connector 100. In the illustrated embodiments of the present disclosure, the electrical connector 100 is a board-end backplane connector which is configured to be mounted on the circuit board 300 and electrically connected to the circuit board 300. In one embodiment of the present disclosure, the electrical connector 100 is fixed to the circuit board 300 by screws (not shown) to improve the fixing strength.

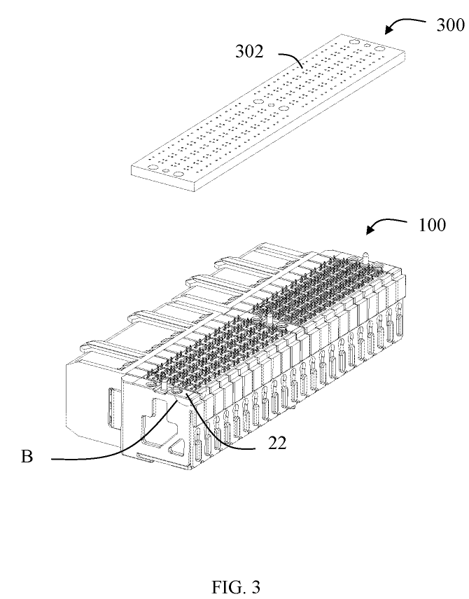

Referring to FIGS. 3,5 and 6, the circuit board 300 includes a first surface 301 (e.g., an upper surface), a second surface 302 (e.g., a lower surface) disposed opposite to the first surface 301, a plurality of first conductive pads 303 disposed on the first surface 301, a plurality of second conductive pads 304 disposed on the first surface 301, and a plurality of mounting through holes 305 extending through the first surface 301 and the second surface 302 along a second direction A2-A2 (e.g., a top-bottom direction). In the illustrated embodiment of the present disclosure, the first conductive pads 303 and the second conductive pads 304 are spaced apart along a first direction A1-A1 (e.g., a front-back direction) and a third direction A3-A3 (e.g., a left-right direction). In the illustrated embodiment of the present disclosure, each two of the first direction A1-A1, the second direction A2-A2 and the third direction A3-A3 are perpendicular to each other. In the illustrated embodiment of the present disclosure, one first conductive pad 303 and one second conductive pad 304 which are disposed adjacent to each other along the third direction A3-A3 form a differential pair conductive pad group to improve the rate of signal transmission. In the illustrated embodiment of the present disclosure, corresponding to each differential pair conductive pad group, the mounting through holes 305 include a first mounting through hole 3051, a second mounting through hole 3052, a third mounting through hole 3053 and a fourth mounting through hole 3054. The first mounting through hole 3051 and the third mounting through hole 3053 are located on one side (e.g., a right side) of the differential pair conductive pad group, while the second mounting through hole 3052 and the fourth mounting through hole 3054 are located on an opposite side (e.g., a right side) of the differential pair conductive pad group. In the illustrated embodiment of the present disclosure, the first mounting through hole 3051 and the second mounting through hole 3052 are disposed on two sides of the first conductive pad 303 along the first direction A1-A1, and the first mounting through hole 3051, the first conductive pad 303 and the second mounting through hole 3052 are aligned along the first direction A1-A1. Similarly, the third mounting through hole 3053 and the fourth mounting through hole 3054 are disposed on two sides of the second conductive pad 304 along the first direction A1-A1, and the third mounting through hole 3053, the second conductive pad 304 and the fourth mounting through hole 3054 are aligned along the first direction A1-A1. Besides, in the illustrated embodiment of the present disclosure, corresponding to each differential pair conductive pad group, the circuit board 300 defines a surrounding groove 306 formed on the first surface 301, and enclosing the first conductive pad 303 and the second conductive pad 304. In the illustrated embodiment of the present disclosure, the surrounding groove 306 has an approximate “8”-shaped configuration. The first mounting through hole 3051 and the third mounting through hole 3053 are located on one side (e.g., a right side) of the surrounding groove 306, while the second mounting through hole 3052 and the fourth mounting through hole 3054 are located on an opposite side (e.g., a left side) of the surrounding groove 306. In the illustrated embodiment of the present disclosure, the circuit board 300 further defines a first positioning through hole 3073 and a second positioning through hole 3074 which extend through the first surface 301 and the second surface 302 along the second direction A2-A2.

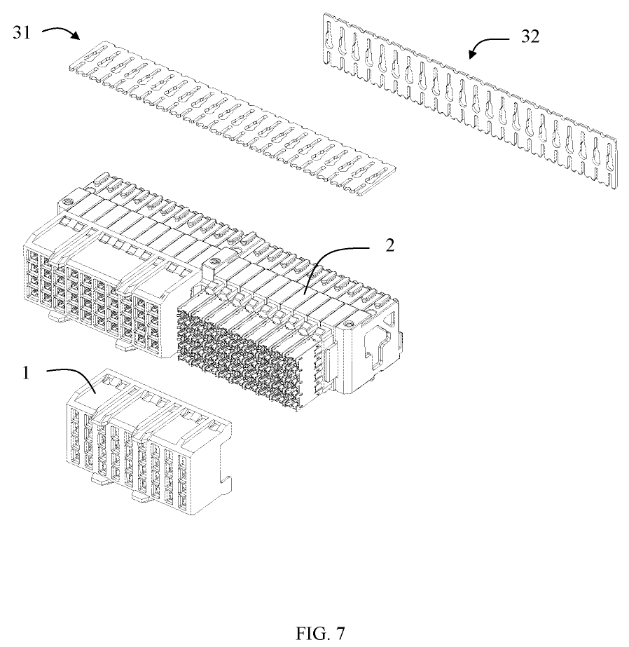

Referring to FIGS. 7-32 , in the illustrated embodiment of the present disclosure, the electrical connector 100 includes a housing 1, an installation module 2 disposed in the housing 1, at least one retaining plate 3 securing the installation module 2 to the housing 1, and a mounting block 4 mounted at a bottom of the housing 1 and mating with the installation module 2.

Referring to FIGS. 7,8 and 10, in one embodiment of the present disclosure, the housing 1 is an insulating housing which is made of insulating material. The housing 1 includes a main body 11, a first wall portion 12 extending backwardly from one end (e.g., an upper end) of the main body 11, and a second wall portion 13 extending backwardly from an opposite end (e.g., a lower end) of the main body 11. The main body 11 includes a mating surface 111 and a plurality of first terminal receiving slots 112 extending through the mating surface 111 along the first direction A1-A1. In the illustrated embodiment of the present disclosure, the first terminal receiving slots 112 are of rectangular configurations, and are arranged in matrix.

The first wall portion 12 includes a plurality of first insertion slots 121 and a plurality of first locking slots 122 communicating with the first insertion slots 121. The second wall portion 13 includes a plurality of second insertion slots 131 and a plurality of second locking slots 132 communicating with the second insertion slots 131. The first locking slots 122 extend upwardly through the first wall portion 12 along the second direction A2-A2. The second locking slots 132 extend downwardly through the second wall portion 13 along the second direction A2-A2. The first locking slots 122 and the second locking slots 132 are configured to lock a front end of the installation module 2 in order to prevent the installation module 2 from being disengaged from the housing 1. One first insertion slot 121 and one second insertion slot 131 which are aligned in a vertical direction together form an installation slot 120 to accommodate corresponding portions of the installation module 2.

The housing 1 further includes a plurality of positioning protrusions 14 which extend forwardly from the first wall portion 12 and the second wall portion 13 along the first direction A1-A1, and protrude beyond the mating surface 111. The positioning protrusions 14 are configured to guide and position a mating connector (not shown) during mating.

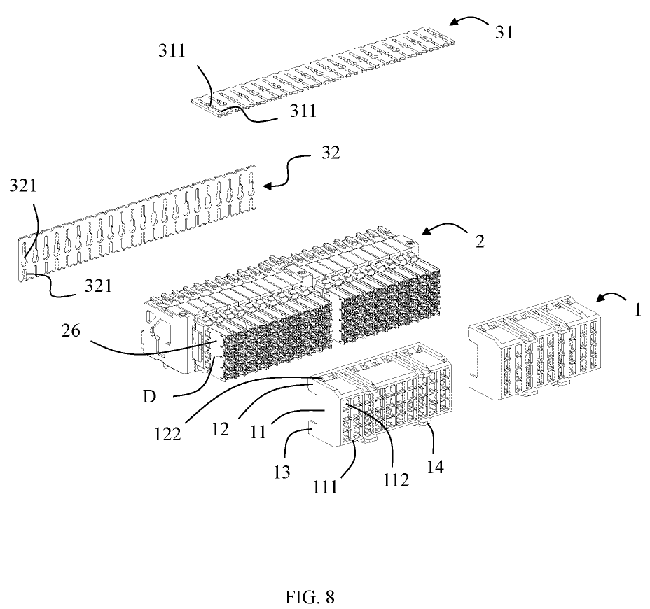

Referring to FIGS. 7 and 8 , the retaining plate 3 is made of metal, and includes a first retaining plate 31 and a second retaining plate 32. The first retaining plate 31 defines a plurality of first retaining grooves 311. The second retaining plate 32 defines a plurality of second retaining grooves 321. The first retaining plate 31 and the second retaining plate 32 are perpendicular to each other.

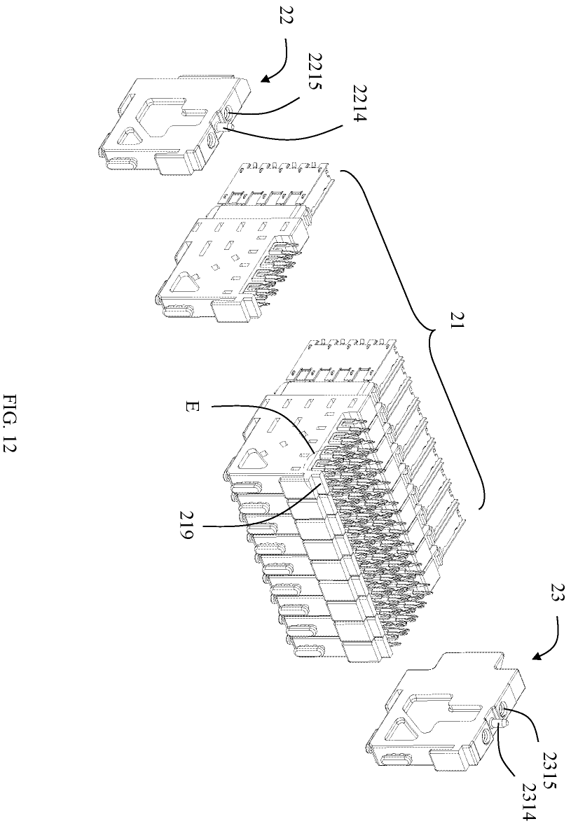

Referring to FIGS. 11 and 12 , in the illustrated embodiment of the present disclosure, the installation module 2 includes a plurality of terminal modules 21, a first mounting plate 22 located on one side of the plurality of terminal modules 21, and a second mounting plate 23 located on another side of the plurality of terminal modules 21. In other words, the plurality of terminal modules 21 are sandwiched between the first mounting plate 22 and the second mounting plate 23 along the third direction A3-A3. In one embodiment of the present disclosure, the first mounting plate 22 and the second mounting plate 23 are both metal mounting plates, i.e., they are made of metal material in order to enhance shielding and structural strength.

In the illustrated embodiment of the present disclosure, all the terminal modules 21 are identical. The following description will take one of the terminal modules 21 as an example.

Referring to FIGS. 11-32 , the terminal module 21 includes a plurality of terminal blocks 211, a first grounding module 212 which is located on a first side (e.g., an outer side) of each terminal block 211, a second grounding module 213 which is located on a second side (e.g., an inner side) of each terminal block 211, a shielding sleeve 214 which is configured to mate with one end of the first grounding module 212 and one end of the second grounding module 213, a first shielding plate 215 which is located on one side of the terminal blocks 211, the first grounding module 212 and the second grounding module 213, a second shielding plate 216 which is located on another side of the terminal blocks 211, the first grounding module 212 and the second grounding module 213, an insulating plate 219 which is fixed to the terminal blocks 211, the first grounding module 212, the second grounding module 213, the first shielding plate 215 and the second shielding plate 216, and an extended shielding shell assembly 26. The shielding sleeve 214 is at least partially sleeved on the terminal block 211. The extended shielding shell assembly 26 is located at a front end of the terminal module 21 and is in contact with the shielding sleeve 214 to improve the shielding effect. The first shielding plate 215 is located on a third side (e.g., a left side) of the terminal blocks 211, and the second shielding plate 216 is located on a fourth side (e.g., a right side) of the terminal blocks 211.

In one embodiment of the present disclosure, the insulating plate 219 is molded and fixed on the terminal blocks 211, the first grounding module 212, the second grounding module 213, the first shielding plate 215 and the second shielding plate 216. The insulating plate 219 includes a first locking protrusion 2191 disposed at a top of the insulating plate 219, a first retaining rib 2192 disposed at the top of the insulating plate 219 and located at a rear of the first locking protrusion 2191, a second locking protrusion 2193 disposed at a bottom of the insulating plate 219, and a second retaining rib 2194 located at a rear side of the insulating plate 219. The insulating plate 219 is configured to be inserted into a corresponding installation slot 120. The first locking protrusion 2191 and the second locking protrusion 2193 are locked in the first locking groove 122 and the second locking groove 132, respectively. A portion of the first retaining groove 311 of the first retaining plate 31 engages with the first retaining rib 2192, and a portion of the second retaining groove 321 of the second retaining plate 32 engages with the second retaining rib 2194.

Each terminal block 211 includes a first conductive terminal S1, a second conductive terminal S2, and an insulating fixing block 2111 at least partially fixed on the first conductive terminal S1 and the second conductive terminal S2.

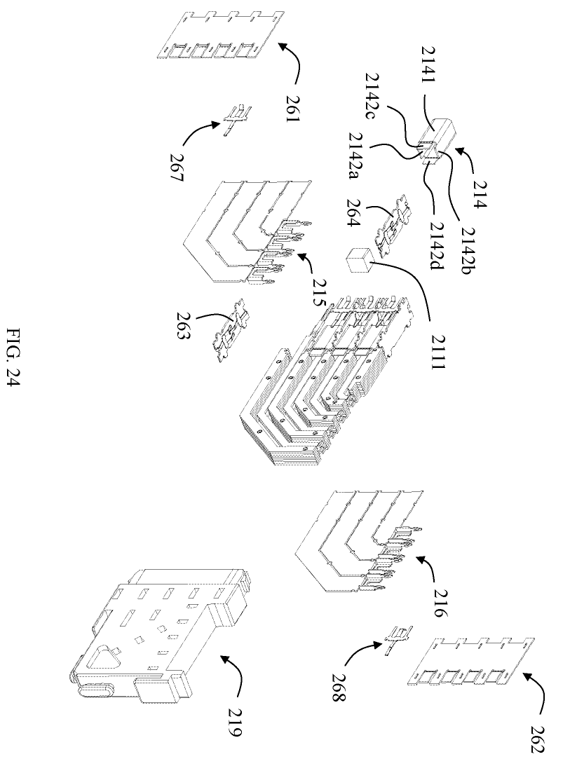

Referring to FIG. 23, each conductive terminal of the terminal block 211 includes a first retaining portion 211a, a first extension portion 211d connected to one end of the first retaining portion 211a, a first contact portion 211b connected to the first extension portion 211d, a second contact portion 211b connected to the first retaining portion 211d, and a first tail portion 211c connected to another end of the first retaining portion 211a. In the illustrated embodiment of the present disclosure, the first retaining portion 211a is of a curved configuration. The first contact portion 211b is needle-shaped and perpendicular to the first tail portion 211c.

In the illustrated embodiment of the present disclosure, the first conductive terminal S1 and the second conductive terminal S2 in each terminal block 211 form a pair of differential signal terminals in order to improve the rate of signal transmission. In the illustrated embodiment of the present disclosure, the first retaining portion 211a of the first conductive terminal S1 and the first retaining portion 211a of the second conductive terminal S2 are arranged side by side along the third direction A3-A3 to achieve broad-side coupling. The first extension portion 211d of the first conductive terminal S1 and the first extension portion 211d of the second conductive terminal S2 are staggered along both the second direction A2-A2 and the third direction A3-A3. Correspondingly, the first contact portion 211b of the first conductive terminal S1 and the first contact portion 211b of the second conductive terminal S2 are staggered along both the second direction A2-A2 and the third direction A3-A3. The insulating fixing block 2111 is over-molded on the first extension portion 211d of the first conductive terminal S1 and the first extension portion 211d of the second conductive terminal S2. The first contact portion 211b of the first conductive terminal S1 and the first contact portion 211b of the second conductive terminal S2 both protrude beyond the insulating fixing block 2111 along the first direction A1-A1.

In the illustrated embodiment of the present disclosure, the first grounding module 212 includes a plurality of first grounding sheets 2121 stacked along the third direction A3-A3. It is understandable to those skilled in the art that in the illustrated embodiment of the present disclosure, the plurality of first grounding sheets 2121 arranged in a stacked manner means that the plurality of first grounding sheets 2121 are disposed adjacent to one another along the third direction A3-A3. That is, the plurality of first grounding sheets 2121 are stacked left and right. Each first grounding sheet 2121 includes a first intermediate portion 2121a, a first engagement portion 2121b connected to one end of the first intermediate portion 2121a, and a first abutting portion 2121c connected to another end of the first intermediate portion 2121a. In the illustrated embodiment of the present disclosure, the first intermediate portion 2121a is of a curved configuration. The first engagement portion 2121b is perpendicular to the first abutting portion 2121c. In the illustrated embodiment of the present disclosure, all the first grounding sheets 2121 are identical in order to reduce costs. In the illustrated embodiment of the present disclosure, the first engagement portion 2121b defines a first positioning groove 2121b1.

Similarly, the second grounding module 213 includes a plurality of second grounding sheets 2131 stacked along the third direction A3-A3. Each second grounding sheet 2131 includes a second intermediate portion 2131a, a second engagement portion 2131b connected to one end of the second intermediate portion 2131a, and a second abutting portion 2131c connected to another end of the second intermediate portion 2131a. The second intermediate portion 2131a is of a curved configuration. The second engagement portion 2131b is perpendicular to the second abutting portion 2131c. All the second grounding sheets 2131 are identical in order to reduce costs. In the illustrated embodiment of the present disclosure, the second engagement portion 2131b defines a second positioning groove 2131b1. The first positioning groove 2121b1 is recessed away from the second mating portion 2131b along the second direction A2-A2. The second positioning groove 2131b1 is recessed away from the first engagement portion 2121b along the second direction A2-A2.

The shielding sleeve 214 includes a sleeve portion 2141 that is sleeved on the insulating fixing block 2111, and a plurality of extension pieces 2142 that extend integrally from the sleeve portion 2141. In the illustrated embodiment of the present disclosure, the sleeve portion 2141 is of a hollow rectangle configuration and has four walls. The extension pieces 2142 include a first extension piece 2142a that extends from at least one of the four walls, a second extension piece 2142b that is disposed opposite to the first extension piece 2142a, a third extension piece 2142c, and a fourth extension piece 2142d that is disposed opposite to the third extension piece 2142c. In the illustrated embodiment of the present disclosure, the first extension piece 2142a is inserted into the first positioning groove 2121b1 to contact the first engagement portion 2121b. The second extension piece 2142b is inserted into the second positioning groove 2131b1 to contact the second engagement portion 2131b. The third extending piece 2142c contacts the first shielding plate 215, and the fourth extending piece 2142d contacts the second shielding plate 216.

In the illustrated embodiment of the present disclosure, the first shielding plate 215 includes a plurality of first shielding sheets 2151. The plurality of first shielding sheets 2151 are provided separately. Each first shielding sheet 2151 is located on one side of the terminal block 211 along the third direction A3-A3. The first shielding sheet 2151 is provided with a first curved portion 2151a, a first extension portion 2151b connected to one end of the first curved portion 2151a, and a first shielding portion 2151c connected to another end of the first curved portion 2151a. In the illustrated embodiment of the present disclosure, the first shielding portion 2151c includes a first side wall 2151c1, a first bent wall 2151c2 bent from one end of the first side wall 2151c1, a second bent wall 2151c3 bent from another end of the first side wall 2151c1, a first mounting leg 2151c4 integrally extending downwardly from the first bent wall 2151c2, and a second mounting leg 2151c5 integrally extending downwardly from the second bent wall 2151c3. The first side wall 2151c1 defines a first opening 2151c6 extending downwardly through the first side wall 2151c1. The first shielding sheet 2151 shields one side of the first conductive terminal S1 and the second conductive terminal S2 along the third direction A3-A3, and is in contact with the first grounding module 212 and the second grounding module 213. In the illustrated embodiment of the present disclosure, the first shielding portion 2151c is in contact with the first abutting portion 2121c. It is understandable to those skilled in the art that, in the illustrated embodiment of the present disclosure, since the first shielding portion 2151c of each first shielding sheet 2151 includes the first side wall 2151c1, the first bent wall 2151c2, the second bent wall 2151c3, the first mounting leg 2151c4, and the second mounting leg 2151c5, the first shielding plate 215 of a single-piece configuration is not able to meet manufacturing feasibility. Therefore, the first shielding plate 215 of the present disclosure includes the plurality of first shielding sheets 2151. This arrangement allows the first shielding portion 2151c of each first shielding sheet 2151 to be designed and manufactured using the material of the first shielding sheet 2151 itself, avoiding interference from other first shielding sheets 2151. In the illustrated embodiment of the present disclosure, the first curved portions 2151a and first extension portions 2151b of all first shielding sheets 2151 are located in a same plane. The first curved portions 2151a of all first shielding sheets 2151 are stacked in this plane, and the first extension portions 2151b of all first shielding sheets 2151 are also stacked in this plane.

In the illustrated embodiment of the present disclosure, the second shielding plate 216 includes a plurality of second shielding sheets 2161. The plurality of second shielding sheets 2161 are provided separately. Each second shielding sheet 2161 is located on another side of the terminal block 211 along the third direction A3-A3. The second shielding sheet 2161 is provided with a second curved portion 2161a, a second extension portion 2161b connected to one end of the second curved portion 2161a, and a second shielding portion 2161c connected to another end of the second curved portion 2161a. In the illustrated embodiment of the present disclosure, the second shielding portion 2161c includes a second side wall 2161c1, a third bent wall 2161c2 bent from one end of the second side wall 2161c1, a fourth bent wall 2161c3 bent from another end of the second side wall 2161c1, a third mounting leg 2161c4 integrally extending downwardly from the third bent wall 2161c2, and a fourth mounting leg 2161c5 integrally extending downwardly from the fourth bent wall 2161c3. The second side wall 2161c1 is provided with a second opening 2161c6 extending downwardly through the second side wall 2161c1. The second shielding sheet 2161 shields another side of the first conductive terminal S1 and the second conductive terminal S2 along the third direction A3-A3, and is in contact with the first grounding module 212 and the second grounding module 213. In the illustrated embodiment of the present disclosure, the second shielding portion 2161c is in contact with the first abutting portion 2121c. It is understandable to those skilled in the art that, in the illustrated embodiment of the present disclosure, since the second shielding portion 2161c of each second shielding sheet 2161 includes the second side wall 2161c1, the third bent wall 2161c2, the fourth bent wall 2161c3, the third mounting leg 2161c4 and the fourth mounting leg 2161c5, the second shielding plate 216 of a single-piece configuration is not able to meet manufacturing feasibility. Therefore, the second shielding plate 216 of the present disclosure includes the plurality of second shielding sheets 2161. This arrangement allows the second shielding portion 2161c of each second shielding sheet 2161 to be designed and manufactured using the material of the second shielding sheet 2161 itself, avoiding interference from other second shielding sheets 2161. In the illustrated embodiment of the present disclosure, the second curved portions 2161a and second extension portions 2161b of all second shielding sheets 2161 are located in a same plane. The second curved portions 2161a of all second shielding sheets 2161 are stacked in this plane, and the second extension portions 2161b of all second shielding sheets 2161 are also stacked in this plane.

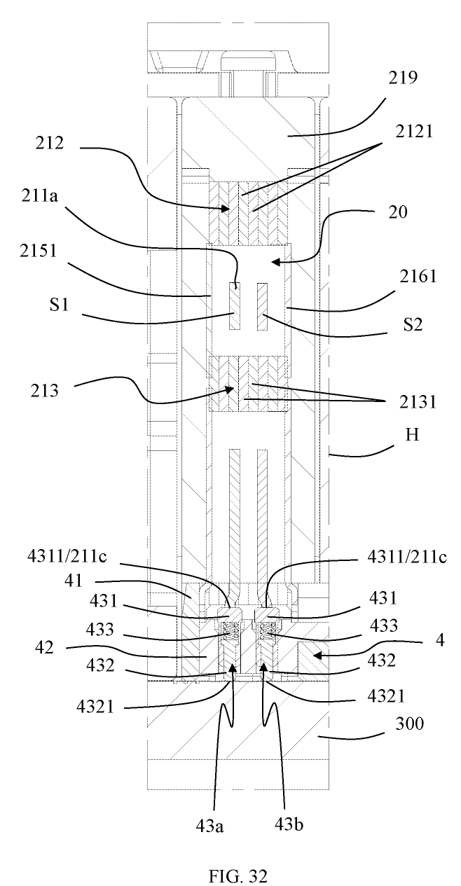

Referring to FIG. 32, in the illustrated embodiment of the present disclosure, the first shielding sheet 2151, the plurality of first grounding sheets 2121 of the first grounding module 212, the plurality of second grounding sheets 2131 of the second grounding module 213, and the second shielding sheet 2161 jointly form a shielding cavity 20 surrounding the terminal block 211 to improve shielding effectiveness. Specifically, the shielding cavity 20 surrounds the first retaining portion 211a of the first conductive terminal S1 and the first retaining portion 211a of the second conductive terminal S2 along their length directions, thereby improving shielding effectiveness and enhancing signal transmission quality. In the illustrated embodiment of the present disclosure, by providing the plurality of first grounding sheets 2121 and the plurality of second grounding sheets 2131, the present disclosure can form the shielding cavity 20 using a thickness of the plurality of first grounding sheets 2121 which are stacked, and a thickness of the plurality of second grounding sheets 2131 which are stacked, respectively, which facilitates the adjustment of the shielding cavity 20 by adjusting the number and thickness of the first grounding sheets 2121 and the second grounding sheets 2131.

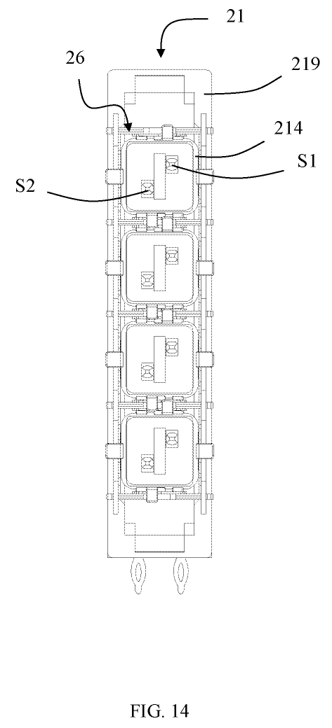

Referring to FIGS. 14-32 , in the illustrated embodiment of the present disclosure, the extension shielding shell assembly 26 includes a first extension shielding piece 261, a second extension shielding piece 262, a first connection shielding piece 263, a second connection shielding piece 264, a first elastic piece group 265 fixed to an inner side of the first connection shielding piece 263, a second elastic piece group 266 fixed to an inner side of the second connection shielding piece 264, a first abutting elastic piece 267 fixed to an inner side of the first extension shielding piece 261, and a second abutting elastic piece 268 fixed to an inner side of the second extension shielding piece 262.

Specifically, in the illustrated embodiment of the present disclosure, the extension shielding shell assembly 26 defines a shielding chamber 260 jointly formed by the first extension shielding piece 261, the second extension shielding piece 262, the first connection shielding piece 263 and the second connection shielding piece 264. The first contact portion 211b of the first signal terminal S1 and the first contact portion 211b of the second signal terminal S2 both protrude into the shielding chamber 260. The extension shielding shell assembly 26 can provide a better shielding effect for the first contact portion 211b of the first signal terminal S1 and the first contact portion 211b of the second signal terminal S2. The first elastic piece group 265, the second elastic piece group 266, the first abutting elastic piece 267 and the second abutting elastic piece 268 all at least partially protrude into the shielding chamber 260.

In the illustrated embodiment of the present disclosure, the first extension shielding piece 261 is made of metal material. The first extension shielding piece 261 extends in the top-bottom direction, and includes a plurality of first mounting holes 2611, a plurality of second mounting holes 2612, and a first contact elastic piece 2613 located between the first mounting hole 2611 and the second mounting hole 2612 along the top-bottom direction. In the illustrated embodiment of the present disclosure, the first extension shielding piece 261 further includes a pair of first slits 2614 that communicate with the first contact elastic piece 2613, and are located on the upper and lower sides of the first contact elastic piece 2613, respectively. The first contact elastic piece 2613 is flat-shaped so as to be better attached to the shielding sleeve 214. In addition, the first extension shielding piece 261 further includes a first groove 2615 that is disposed opposite to the first contact elastic piece 2613.

Similarly, the second extension shielding piece 262 is made of metal material. The second extension shielding piece 262 extends in the top-bottom direction, and includes a plurality of third mounting holes 2621, a plurality of fourth mounting holes 2622, and a second contact elastic piece 2623 located between the third mounting hole 2621 and the fourth mounting hole 2622 along the top-bottom direction. In the illustrated embodiment of the present disclosure, the second extension shielding piece 262 further includes a pair of second slits 2624 that communicate with the second contact elastic piece 2623, and are located on the upper and lower sides of the second contact elastic piece 2623, respectively. The second contact elastic piece 2623 is flat-shaped so as to be better attached to the shielding sleeve 214. In addition, the second extension shielding piece 262 further includes a second groove 2625 opposite to the second contact elastic piece 2623.

The first connection shielding piece 263 is flat-shaped and made of metal material. The first connection shielding piece 263 extends substantially horizontally along the first direction A1-A1. The first connection shielding piece 263 includes a plurality of first protruding portions 2631 fixed in the first mounting holes 2611 and a plurality of second protruding portions 2632 fixed in the third mounting holes 2621. The first protruding portions 2631 and the second protruding portions 2632 are located on the left and right sides of the first connection shielding piece 263, respectively. The first connection shielding piece 263 is further provided with a first relief groove 2633 and a second relief groove 2634 which are disposed at two ends in the front and rear directions, respectively. The first connection shielding piece 263 is further provided with a first fixing groove 2635 and a second fixing groove 2636 which are located on the left and right sides, respectively.

Similarly, the second connection shielding piece 264 is flat-shaped and made of metal material. The second connection shielding piece 264 extends substantially horizontally along the first direction A1-A1. The second connection shielding piece 264 includes a plurality of third protruding portions 2641 fixed in the second mounting holes 2612 and a plurality of fourth protruding portions 2642 fixed in the fourth mounting holes 2622. The third protruding portions 2641 and the fourth protruding portions 2642 are located on the left and right sides of the second connection shielding piece 264, respectively. The second connection shielding piece 264 is further provided with a third relief groove 2643 and a fourth relief groove 2644 which are disposed at two ends in the front and rear directions, respectively. The second connection shielding piece 264 is further provided with a third fixing groove 2645 and a fourth fixing groove 2646 which are located on the left and right sides, respectively.

In the illustrated embodiment of the present disclosure, the first elastic piece group 265 is made of metal material. The first elastic piece group 265 includes a first elastic piece 265a and a second elastic piece 265b. The first elastic piece 265a includes a first fixing portion 265a0, at least one first elastic arm 265a1 extending from one end of the first fixing portion 265a0, and at least one second elastic arm 265a2 extending from another end of the first fixing portion 265a0. The number and structural form of the first elastic arm 265a1 and the second elastic arm 265a2 can be flexibly adjusted as needed. In the illustrated embodiment of the present disclosure, the first fixing portion 265a0 is fixed to a lower surface of the first connection shielding piece 263. For example, the first fixing portion 265a0 is fixed to the lower surface of the first connection shielding piece 263 by soldering or welding. The first elastic arm 265a1 and the second elastic arm 265a2 are both cantilever arms, that is, they respectively have free ends away from the first fixing portion 265a0.

The second elastic piece 265b includes a second fixing portion 265b0, at least one third elastic arm 265b1 extending from one end of the second fixing portion 265b0, and at least one fourth elastic arm 265b2 extending from another end of the second fixing portion 265b0. In the first embodiment illustrated in the present disclosure, the third elastic arm 265b1 and the fourth elastic arm 265b2 of the second elastic piece 265b are always in contact with the shielding sleeve 214. When the second elastic piece 265b is abutted against and deformed by the shielding sleeve 214, the free end of the third elastic arm 265b1 is movable in the second relief groove 2634. The number and structural form of the third elastic arm 265b1 and the fourth elastic arm 265b2 can be flexibly adjusted as needed. In the illustrated embodiment of the present disclosure, the second fixing portion 265b0 is fixed to the lower surface of the first connection shielding piece 263. For example, the second fixing portion 265b0 is fixed to the lower surface of the first connection shielding piece 263 by soldering or welding. The third elastic arm 265b1 and the fourth elastic arm 265b2 are both cantilever arms, that is, they respectively have free ends away from the second fixing portion 265b0. The third elastic arm 265b1 and the fourth elastic arm 265b2 are configured to abut against the second backplane connector 200. The free end of the fourth elastic arm 265b2 is movable in the second relief groove 2634.

In the illustrated embodiment of the present disclosure, the first elastic piece 265a and the second elastic piece 265b are provided separately, and are fixed to the lower surface of the first connection shielding piece 263 by soldering or welding. With this arrangement, the first connection shielding piece 263 itself can be made of metal materials of different materials and/or thicknesses to meet the requirements of structural strength and shielding performance. In addition, the first connection shielding piece 263 and the first elastic piece group 265 are provided separately, which can avoid integrally stamping the first elastic piece group 265 on the first connection shielding piece 263 and leaving openings that may affect the shielding effect.

Of course, it is understandable to those skilled in the art that in other embodiments of the present disclosure, the first elastic piece 265a and the second elastic piece 265b can also be integrally formed.

In the illustrated embodiment of the present disclosure, two third elastic arms 265b1 are provided, and the second elastic piece 265b includes a first receiving groove 265b3 located between the two third elastic arms 265b1. The second elastic arm 265a2 protrudes into the first receiving groove 265b3 along the first direction A1-A1 (for example, the front-back direction) in its free state. In other words, in the free state of the first elastic piece 265a and the second elastic piece 265b, the second elastic arm 265a2 and the third elastic arm 265b1 at least partially overlap in the third direction A3-A3 (for example, the left-right direction).

In the illustrated embodiment of the present disclosure, the second elastic piece group 266 is made of metal material. The second elastic piece group 266 includes a third elastic piece 266a and a fourth elastic piece 266b. The third elastic piece 266a includes a third fixing portion 266a0, at least one fifth elastic arm 266a1 extending from one end of the third fixing portion 266a0, and at least one sixth elastic arm 266a2 extending from another end of the third fixing portion 266a0. The number and structural form of the fifth elastic arm 266a1 and the sixth elastic arm 266a2 can be flexibly adjusted as needed. In the illustrated embodiment of the present disclosure, the third fixing portion 266a0 is fixed to an upper surface of the second connection shielding piece 264. For example, the third fixing portion 266a0 is fixed to the upper surface of the second connection shielding piece 264 by soldering or welding. The fifth elastic arm 266a1 and the sixth elastic arm 266a2 are both cantilever arms, that is, they respectively have free ends away from the third fixing portion 266a0.

The fourth elastic piece 266b includes a fourth fixing portion 266b0, at least one seventh elastic arm 266b1 extending from one end of the fourth fixing portion 266b0, and at least one eighth elastic arm 266b2 extending from another end of the fourth fixing portion 266b0. In the first embodiment illustrated in the present disclosure, the seventh elastic arm 266b1 and the eighth elastic arm 266b2 of the fourth elastic piece 266b are always in contact with the shielding sleeve 214. When the fourth elastic piece 266b is abutted against and deformed by the shielding sleeve 214, the free end of the seventh elastic arm 266b1 is movable in the fourth relief groove 2644. The number and structural form of the seventh elastic arm 266b1 and the eighth elastic arm 266b2 can be flexibly adjusted as needed. In the illustrated embodiment of the present disclosure, the fourth fixing portion 266b0 is fixed to the upper surface of the second connection shielding piece 264. For example, the fourth fixing portion 266b0 is fixed to the upper surface of the second connection shielding piece 264 by soldering or welding. The seventh elastic arm 266b1 and the eighth elastic arm 266b2 are both cantilever arms, that is, they respectively have free ends away from the fourth fixing portion 266b0. The seventh elastic arm 266b1 and the eighth elastic arm 266b2 are configured to abut against the second backplane connector 200. The free end of the eighth elastic arm 266b2 is movable in the fourth relief groove 2644.

In the illustrated embodiment of the present disclosure, the third elastic piece 266a and the fourth elastic piece 266b are provided separately, and are fixed to the upper surface of the second connection shielding piece 264 by soldering or welding. With this arrangement, the second connection shielding piece 264 itself can be made of metal materials of different materials and/or thicknesses to meet the requirements of structural strength and shielding performance. In addition, the second connection shielding piece 264 and the second elastic piece group 266 are provided separately, which can avoid integrally stamping and forming the second elastic piece group 266 on the second connection shielding piece 264, which may leave openings that may affect the shielding effect.

Of course, it is understandable to those skilled in the art that in other embodiments of the present disclosure, the third elastic piece 266a and the fourth elastic piece 266b can also be integrally formed.

In the illustrated embodiment of the disclosure, two seventh elastic arms 266b1 are provided, and the fourth elastic piece 266b includes a second receiving groove 266b3 located between the two seventh elastic arms 266b1. The sixth elastic arm 266a2 protrudes into the second receiving groove 266b3 along the first direction A1-A1 in its free state. In other words, in the free state of the third elastic piece 266a and the fourth elastic piece 266b, the sixth elastic arm 266a2 and the seventh elastic arm 266b1 at least partially overlap in the third direction A3-A3.

The first abutting elastic piece 267 includes a first holding portion 2670, at least one first abutting elastic arm 2671 extending from one end of the first holding portion 2670, at least one second abutting elastic arm 2672 extending from another end of the first holding portion 2670, and a first support portion 2673 and the second support portion 2674 which are located on the upper and lower sides of the first abutting elastic arm 2671, respectively. The number and structural form of the first contact elastic arm 2671 and the second contact elastic arm 2672 can be flexibly adjusted as needed. In the illustrated embodiment of the present disclosure, the first holding portion 2670 is fixed to the inner surface of the first extension shielding piece 261. For example, the first holding portion 2670 is fixed to an inner surface of the first extension shielding piece 261 by soldering or welding. The first abutting elastic arm 2671 and the second abutting elastic arm 2672 are both cantilever arms, that is, they respectively have free ends away from the first holding portion 2670. When the first abutting elastic piece 267 is deformed, the free end of the first abutting elastic arm 2671 is movable in the first groove 2615. The first support portion 2673 is provided with a first fixing tab 2673a that is fixed in the first fixing groove 2635. The second support portion 2674 is provided with a second fixing tab 2674a that is fixed in the third fixing groove 2645.

The second abutting elastic piece 268 includes a second holding portion 2680, at least one third abutting elastic arm 2681 extending from one end of the second holding portion 2680, at least one fourth abutting elastic arm 2682 extending from another end of the second holding portion 2680, and a third support portion 2683 and a fourth support portion 2684 which are located on the upper and lower sides of the third abutting elastic arm 2681, respectively. The number and structural form of the third contact elastic arm 2681 and the fourth contact elastic arm 2682 can be flexibly adjusted as needed. In the illustrated embodiment of the present disclosure, the second holding portion 2680 is fixed to an inner surface of the second extension shielding piece 262. For example, the second holding portion 2680 is fixed to the inner surface of the second extension shielding piece 262 by soldering or welding. The third abutting elastic arm 2681 and the fourth abutting elastic arm 2682 are both cantilever arms, that is, they respectively have free ends away from the second holding portion 2680. When the second abutting elastic piece 268 is deformed, the free end of the third abutting elastic arm 2681 is movable in the second groove 2625. The third support portion 2683 is provided with a third fixing tab 2683a that is fixed in the second fixing groove 2636. The fourth support portion 2684 is provided with a fourth fixing tab 2684a that is fixed in the fourth fixing groove 2646.

In the illustrated embodiment of the present disclosure, in order to save costs as much as possible, the first extension shielding piece 261 and the second extension shielding piece 262 may be shared parts; the first connection shielding piece 263 and the second connection shielding piece 264 may be shared parts; the first elastic piece 265aand the third elastic piece 266a may be shared parts; the second elastic piece 265band the fourth elastic piece 266b may be shared parts; and the first abutting elastic piece 267 and the second abutting elastic piece 268 may be shared parts.

In the first embodiment of the present disclosure, the first elastic arm 265a1 and the second elastic arm 265a2 of the first elastic piece 265a are spaced apart along the first direction A1-A1 to form two layers of ground contacting points, thereby improving the ground shielding effect. Similarly, the fifth elastic arm 266a1 and the sixth elastic arm 266a2 of the third elastic piece 266a are spaced apart along the first direction A1-A1 to form two layers of ground contacting points, thereby improving the ground shielding effect.

In the embodiment of the present disclosure, the first elastic piece 265a and the second elastic piece 265b are fixed to the first connection shielding piece 263; the third elastic piece 266a and the fourth elastic piece 266b are fixed to the second connection shielding piece 264; the first abutting elastic piece 267 is fixed to the first extension shielding piece 261; and the second abutting elastic piece 268 is fixed to the second extension shielding piece 262. Of course, it is understandable to those skilled in the art that the positions of the first elastic piece 265a and the second elastic piece 265b, the positions of the third elastic piece 266a and the fourth elastic piece 266b, and the positions of the first abutting elastic piece 267 and the second abutting elastic piece 268 can also be exchanged. For example, the first elastic piece 265a and the second elastic piece 265b are fixed to the first extension shielding piece 261; the third elastic piece 266a and the fourth elastic piece 266b are fixed to the second extension shielding piece 262; the first abutting elastic piece 267 is fixed to the first connection shielding piece 263; and the second abutting elastic piece 268 is fixed to the second connection shielding piece 264.

In addition, by providing the extension shielding shell assembly 26 as a separate part, the present disclosure reduces the design complexity of the terminal module 21.

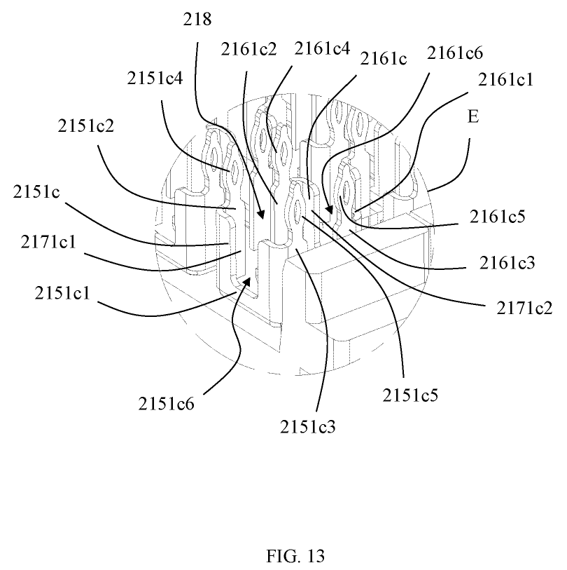

Referring to FIG. 13, in one embodiment of the present disclosure, the first shielding portion 2151c of the first shielding plate 215 and the second shielding portion 2161c of the second shielding plate 216 form a shielding space 218. Specifically, the first side wall 2151c1 and second side wall 2161c1 are arranged opposite to each other. The first bent wall 2151c2 and the third bent wall 2161c2 extend toward each other to form a third side wall 2171c1. The first bent wall 2151c2 and the third bent wall 2161c2 extend face to face and approach each other. A third opening 2171c2 is formed between the first bent wall 2151c2 and the third bent wall 2161c2. The second bent wall 2151c3 and the fourth bent wall 2161c3 extend toward each other to form a fourth side wall . The second bent wall 2151c3 and the fourth bent wall 2161c3 extend face to face and approach each other. A fourth opening is formed between the second bent wall 2151c3 and the fourth bent wall 2161c3. The third side wall 2171c1 and the fourth side wall are arranged opposite to each other. The shielding space 218 is enclosed by the first side wall 2151c1, the second side wall 2161c1, the third side wall 2171c1 and the fourth side wall .

Since the first tail portion 211c of the first conductive terminal S1 and the first tail portion 211c of the second conductive terminal S2 both extend downwardly and protrude beyond the shielding cavity 20, the terminal module 21 defines the shielding space 218 to enhance the shielding effect on the first tail portion 211c of the first conductive terminal S1 and the first tail portion 211c of the second conductive terminal S2. The first tail portion 211c of the first conductive terminal S1 and the first tail portion 211c of the second conductive terminal S2 are both located at least partially in the shielding space 218.

Each of the first mounting leg 2151c4, the second mounting leg 2151c5, the third mounting leg 2161c4 and the fourth mounting leg 2161c5 defines a fish-eye hole, so that the first mounting leg 2151c4, the second mounting leg 2151c5, the third mounting leg 2161c4 and the fourth mounting leg 2161c5 all have certain elasticity. The first mounting leg 2151c4, the second mounting leg 2151c5, the third mounting leg 2161c4 and the fourth mounting leg 2161c5 are configured to be pressed into the first mounting through hole 3051, the second mounting through hole 3052, the third mounting through hole 3053 and the fourth mounting through hole 3054, respectively, to establish the electrical connection with the circuit board 300. In one embodiment of the present disclosure, the first mounting through hole 3051, the second mounting through hole 3052, the third mounting through hole 3053 and the fourth mounting through hole 3054 are all conductive holes. The first mounting leg 2151c4, the second mounting leg 2151c5, the third mounting leg 2161c4 and the fourth mounting leg 2161c5 are located on two sides of the first tail portion 211c of the first conductive terminal S1 and the first tail portion 211c of the second conductive terminal S2. When first adapter terminals 43a and second adapter terminals 43b elastically abut against the circuit board 300, the reliability of contact between the first elastic abutting leg 2114 and the circuit board 300, and the reliability of contact between arcuate contact surfaces 4321 and conductive pads of the circuit board 300 are ensured.

Referring to FIGS. 11 and 12 , in one embodiment of the present disclosure, the first mounting plate 22 includes a first main body portion 221 and a first limiting side plate 222 protruding forwardly from the first main body portion 221 along the first direction A1-A1. The first main body portion 221 is provided with a plurality of first fixing ribs 2211 on a top thereof, a first fastening hole 2212 extending upwardly through the first main body portion 221, a plurality of second fixing ribs 2213 protruding backwardly from the first main body portion 221, a first positioning post 2214 protruding downwardly from the first main body portion 221, and a first threaded hole 2215 extending downwardly through the first main body portion 221. The first main body portion 221 abuts an outer side of a corresponding terminal module 21 along the third direction A3-A3, and the first limiting side plate 222 abuts the housing 1. A portion of the first retaining groove 311 of the first retaining plate 31 engages with the first fixing rib 2211, and a portion of the second retaining groove 321 of the second retaining plate 32 engages with the second fixing rib 2213.

In one embodiment of the present disclosure, the second mounting plate 23 includes a second main body portion 231 and a second limiting side plate 232 protruding forwardly from the second main body portion 231 along the first direction A1-A1. The second main body portion 231 is provided with a plurality of third fixing ribs 2311 on a top thereof, a second fastening hole 2312 extending upwardly through the second main body portion 231, a plurality of fourth fixing ribs 2313 protruding backwardly from the second main body portion 231, a second positioning post 2314 protruding downwardly from the second main body portion 231, and a second threaded hole 2315 extending downwardly through the second main body portion 231. The second main body portion 231 abuts an outer side of another corresponding terminal module 21 along the third direction A3-A3, and the second limiting side plate 232 abuts the housing 1. Another portion of the first retaining groove 311 of the first retaining plate 31 engages with the third fixing rib 2311, and another portion of the second retaining groove 321 of the second retaining plate 32 engages with the fourth fixing rib 2313.

By providing the first retaining plate 31 and the second retaining plate 32, the present disclosure is able to fix the first mounting plate 22, the plurality of terminal modules 21, and the second mounting plate 23 as a whole. The first positioning post 2214 and the second positioning post 2314 are inserted into the first positioning through hole 3073 and the second positioning through hole 3074, respectively, to achieve positioning.

Referring to FIGS. 27-32 , the mounting block 4 includes a mounting base 41, a plurality of insulating plastics 42 mounted in the mounting base 41, and a plurality of terminal groups 43 disposed in the insulating plastics 42. In one embodiment of the present disclosure, the mounting base 41 is made of electroplated plastic or conductive plastic so as to mate with the circuit board 300 for improving the shielding effect. The mounting base 41 defines a plurality of through-holes 411 extending through the mounting base 41 along the second direction A2-A2 and at least one positioning recessed groove 412 located beside the through-holes 411. In the illustrated embodiment of the present disclosure, the through-holes 411 are arranged in rows and columns.

Correspondingly, the insulating plastics 42 are arranged in rows and columns, and mounted in the through-holes 411. Each insulating plastic 42 includes a base 421 and at least one positioning rib 422 protruding outward from the base 421. The base 421 includes a first end surface 4211, a second end surface 4212 disposed opposite to the first end surface 4211, a first terminal receiving hole 4213 extending along the second direction A2-A2 through the first end surface 4211 and the second end surface 4212, and a second terminal receiving hole 4214 extending along the second direction A2-A2 through the first end face and the second end surface 4212. The first terminal receiving hole 4213 and the second terminal receiving hole 4214 are arranged side by side. Furthermore, the base 421 defines a groove 4215 recessed from the second end surface 4212 toward the first end surface 4211. Both the first terminal receiving hole 4213 and the second terminal receiving hole 4214 are in communication with the groove 4215. The positioning rib 422 is configured to be received in the positioning recessed groove 412 for positioning.

The terminal group 43 includes a first adapter terminal 43a and a second adapter terminal 43b. In the embodiment illustrated in the present disclosure, the first adapter terminal 43a and the second adapter terminal 43b are both Pogo pins. Each of the first adapter terminal 43aand the second adapter terminal 43b includes a cylindrical portion 431, a terminal portion 432, and an elastic component 433 (e.g., a coil spring) provided between the cylindrical portion 431 and the terminal portion 432. Under the action of the coil spring, the terminal portion 432 is elastically floatable along the third direction A3-A3 relative to the cylindrical portion 431. The cylindrical portion 431 is provided with an abutting surface 4311. The terminal portion 432 is provided with an arcuate contact surface 4321.

After the terminal group 43 and the insulating plastic 42 are assembled, the first adapter terminal 43a and the second adapter terminal 43b are installed in the first terminal receiving hole 4213 and the second terminal receiving hole 4214, respectively. The cylindrical portion 431 of the first adapter terminal 43a and the cylindrical portion 431 of the second adapter terminal 43b at least partially protrude into the groove 4215. The abutting surface 4311 of the first adapter terminal 43a and the abutting surface 4311 of the second adapter terminal 43b are located in the groove 4215. The terminal portion 432 of the first adapter terminal 43a and the terminal portion 432 of the second adapter terminal 43b protrude beyond the first end surface 4211. The abutting surface 4311 of the first adapter terminal 43a is in contact with the first tail portion 211c of the first signal terminal S1. The abutting surface 4311 of the second adapter terminal 43b is in contact with the first tail portion 211c of the second signal terminal S2. The arcuate contact surface 4321 of the terminal portion 432 of the first adapter terminal 43a is configured to elastically abut against the first conductive pad 303 of the circuit board 300. The arcuate contact surface 4321 of the terminal portion 432 of the second adapter terminal 43b is configured to elastically abut against the second conductive pad 304 of the circuit board 300.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a housing, the housing defining an installation slot;
a terminal module, the terminal module being at least partially disposed in the installation slot; the terminal module comprising a first conductive terminal, and the first conductive terminal comprising a first contact portion and a first tail portion; and
a mounting block, the mounting block being mounted to the terminal module, the mounting block comprising an insulating plastic and a first adapter terminal disposed in the insulating plastic, the first adapter terminal comprising a terminal portion and an elastic component abutting against the terminal portion;
wherein the first adapter terminal is electrically connected to the first tail portion of the first conductive terminal, and the terminal portion is configured to be movable along a telescopic direction of the elastic component.

2. The electrical connector according to claim 1, wherein the first adapter terminal is in contact with the first tail portion of the first conductive terminal.

3. The electrical connector according to claim 1, wherein the first adapter terminal comprises a cylindrical portion in which the elastic component is at least partially accommodated, and the terminal portion is floatable relative to the cylindrical portion under an action of the elastic component.

4. The electrical connector according to claim 1, wherein the terminal portion is provided with an arcuate contact surface configured to elastically abut against a first conductive pad of a circuit board.

5. The electrical connector according to claim 1, wherein the mounting block comprises a mounting base, the mounting base defines a through-hole, and the insulating plastic is accommodated in the through-hole.

6. The electrical connector according to claim 5, wherein the mounting base defines a positioning recessed groove located beside the through-hole, the insulating plastic comprises a positioning rib, and the positioning rib is inserted into the positioning recessed groove.

7. The electrical connector according to claim 5, wherein the insulating plastic comprises a base portion, the base portion is provided with a first end surface, a second end surface disposed opposite to the first end surface, a first terminal receiving hole extending through the first end surface and the second end surface, and a groove recessed from the second end surface towards the first end surface; the first terminal receiving hole is in communication with the groove; the cylindrical portion partially protrudes into the groove and does not protrude beyond the second end surface, and the terminal portion protrudes beyond the first end surface.

8. The electrical connector according to claim 1, wherein the terminal module comprises a first terminal module, a first grounding module, a second grounding module, a first shielding plate and a second shielding plate; the first grounding module is located on a first side of the first terminal module, the second grounding module is located on a second side of the first terminal module, the first shielding plate is located on a third side of the first terminal module, the second shielding plate is located on a fourth side of the first terminal module; the first side and the second side are oppositely arranged, the third side and the fourth side are oppositely arranged; the first conductive terminal is provided on the first terminal module;
the first grounding module comprises a plurality of first grounding sheets which are stacked; the first grounding sheets, the second grounding module, the first shielding plate and the second shielding plate are jointly enclosed to form a shielding cavity;
at least part of the first terminal module is accommodated in the shielding cavity.

9. The electrical connector according to claim 8, wherein the second grounding module comprises a plurality of second grounding sheets which are stacked, and the shielding cavity is jointly enclosed by the first grounding sheets, the second grounding sheets, the first shielding plate and the second shielding plate.

10. The electrical connector according to claim 8, wherein the first shielding plate comprises at least one first shielding sheet, and the first shielding sheet is provided with a first shielding portion;
the second shielding plate comprises at least one second shielding sheet, and the second shielding sheet is provided with a second shielding portion;
the first shielding portion is provided with a first mounting leg and a second mounting leg, the second shielding portion is provided with a third mounting leg and a fourth mounting leg, and the first mounting leg, the second mounting leg, the third mounting leg and the fourth mounting leg are all configured to be mounted to a circuit board.

11. The electrical connector according to claim 10, wherein the first shielding portion and the second shielding portion form a shielding space in which the first tail portion of the first conductive terminal is located.

12. The electrical connector according to claim 1, wherein the terminal module comprises an extended shielding shell assembly; the extended shielding shell assembly comprises a first extension shielding piece, a second extension shielding piece disposed opposite to the first extension shielding piece, a first connection shielding piece, and a second connection shielding piece disposed opposite to the first connection shielding piece; the first extension shielding piece, the second extension shielding piece, the first connection shielding piece and the second connection shielding piece are jointly enclosed to form a shielding chamber, and the first contact portion of the first conductive terminal is at least partially located in the shielding chamber.

13. The electrical connector according to claim 12, wherein the extended shielding shell assembly comprises a first elastic piece group fixed to an inner side of the first connection shielding piece, a second elastic piece group fixed to an inner side of the second connection shielding piece, a first abutting elastic piece fixed to an inner side of the first extension shielding piece, and a second abutting elastic piece fixed to an inner side of the second extension shielding piece; each of the first elastic piece group, the second elastic piece group, the first abutting elastic piece and the second abutting elastic piece is provided with at least one elastic arm at least partially protruding into the shielding chamber.

14. The electrical connector according to claim 12, wherein the terminal module comprises a shielding sleeve sleeved on the first terminal module, the shielding sleeve is in contact with the first grounding module and the second grounding module, and the extended shielding shell assembly is in contact with the shielding sleeve.

15. A connector assembly, comprising:
an electrical connector comprising:
a housing defining an installation slot;
a terminal module being at least partially disposed in the installation slot; the terminal module comprising a first conductive terminal, and the first conductive terminal comprising a first contact portion and a first tail portion; and
a mounting block being mounted to the terminal module, the mounting block comprising an insulating plastic and a first adapter terminal disposed in the insulating plastic, the first adapter terminal comprising a terminal portion and an elastic component abutting against the terminal portion;
wherein the first adapter terminal is electrically connected to the first tail portion of the first conductive terminal, and the terminal portion is configured to be movable along a telescopic direction of the elastic component; and
a circuit board provided with a first conductive pad;
wherein the terminal portion of the electrical connector is configured to elastically abut against the first conductive pad of the circuit board.

16. The connector assembly according to claim 15, wherein the circuit board defines a first mounting through hole and a second mounting through hole;
the electrical connector comprises an installation module; the installation module comprises the terminal module, a first mounting plate located on one side of the terminal module, and a second mounting plate located on another side of the terminal module; the first mounting plate and the second mounting plate are both metal mounting plates; the first mounting plate is provided with a first positioning post inserted into the first mounting through hole, and the second mounting plate is provided with a second positioning post inserted into the second mounting through hole.

17. The connector assembly according to claim 15, wherein the first adapter terminal is in contact with the first tail portion of the first conductive terminal.

18. The connector assembly according to claim 15, wherein the first adapter terminal comprises a cylindrical portion in which the elastic component is at least partially accommodated, and the terminal portion is floatable relative to the cylindrical portion under an action of the elastic component.

19. The connector assembly according to claim 15, wherein the terminal portion is provided with an arcuate contact surface configured to elastically abut against a first conductive pad of a circuit board.

20. The connector assembly according to claim 15, wherein the mounting block comprises a mounting base, the mounting base defines a through-hole, and the insulating plastic is accommodated in the through-hole.
